(19) United States
(12) Patent Application Publication
(10) Pub. No.: US 2019/0076314 A1
(43) Pub. Date: Mar. 14, 2019

(54) Transfer Chair

(71) Applicant: Vadim Gordin, Louisville, KY (US)

(72) Inventor: Vadim Gordin, Louisville, KY (US)

(21) Appl. No.: 16/129,323

(22) Filed: Sep. 12, 2018

Related U.S. Application Data
(60) Provisional application No. 62/557,305, filed on Sep. 12, 2017.

(51) Int. Cl. A61G 7/10; A61G 5/10

(52) U.S. Cl. CPC A61G 7/1025; A61G 7/1059; A61G 5/128; A61G 5/1059; A61G 2200/34; A61G 7/1046

(57) ABSTRACT

Patient transfer chairs are disclosed, with the transfer chairs comprising; a rigid frame supporting a seating surface, with the seating surface being deployable under a patient in a plurality of incremental configurations between a first configuration where the seating surface supports a patient only underneath the bend of their knee and a second configuration where the seating surface supports the majority of a patient's femur.

### PRIORITY

This application claims priority to provisional patent application 62/557,305 filed on Sep. 12, 2017. That application is hereby incorporated by reference herein in its entirety.

### BACKGROUND/FIELD

The process of transferring infirmed individuals between a car and wheelchair is presently dangerous for both caregivers and patients. To that end, devices are disclosed herein which provide for a safer patient transfer process between a car and a wheelchair in particular and any seated position such as a chair or the edge of a bed in general.

### SUMMARY

Patient transfer chairs are disclosed, with the transfer chairs comprising; a rigid frame supporting a seating surface, with the seating surface being deployable under a patient in a plurality of incremental configurations between a first configuration where the seating surface supports a patient only underneath the bend of their knee and a second configuration where the seating surface supports the majority of a patient's femur.

According to certain embodiments of the present disclosure, a wheelchair includes; a frame having a plurality of wheels in contact with the ground therebelow, a seating surface coupled to the frame by three generally vertical connectors on each side of the seating surface with each connector extending generally downward from the frame to the seating surface, with the connectors defining two seating surface segments which run left to right along the seat, and each segment being individually detachable from its corresponding connectors along at least one side of the seating surface.

According to further embodiments of the present disclosure, the distance between the ground and the seating surface is adjustable.

According to further embodiments of the present disclosure, the length of the connector between the frame and the seating surface is adjustable.

According to further embodiments of the present disclosure, the connectors are flexible cables or straps.

According to further embodiments of the present disclosure, the length of the connectors is adjustable.

According to further embodiments of the present disclosure, a connector comprises two portions, a first portion that connects the seating surface to the frame defining the distance X therebetween and a second portion which extends beyond X, wherein the ratio of the length of the first portion to the second portion is adjustable to regulate X.

According to further embodiments of the present disclosure, there is a rigid member coupled to the seating surface running left to right along at least the boundary of the first and second segments.

According to further embodiments of the present disclosure, there are 4 seating surface segments.

According to further embodiments of the present disclosure, the height from the ground of the portion of the frame to which the connectors are suspended is adjustable.

According to certain embodiments of the present disclosure, a wheelchair includes; a rigid frame having wheels near a bottom portion of the frame, with the wheels resting upon the ground, and with the frame supporting a seating surface from a top portion of the frame, with the seating surface being deployable under a seated patient in incremental configurations between a first configuration in which the seating surface extends only under the area directly behind the bend of the patient's knee and a second configuration in which the seating surface extends underneath the majority of a patient's thigh.

According to certain embodiments of the present disclosure, a wheelchair includes; a rigid frame and seating surface coupled to the frame, with the seating surface being sized and shaped to support a seated user in three configurations, a first configuration in which the seating surface is disposed away from and provides no support for the user's thigh, a second configuration in which a first portion of the seating surface is disposed below and supports a first portion of the user's thigh extending from behind the user's knee to a point between his knee and hip, and a third configuration in which a second portion of the seating surface is disposed below and supports a second portion of the user's thigh extending from the first portion of his thigh to a point posterior therefrom.

### BRIEF DESCRIPTION OF THE FIGURES

In the figures, which are not necessarily drawn to scale, like numerals describe substantially similar components throughout the several views. The drawings illustrate generally, by way of example, but not by way of limitation, various embodiments discussed in the claims of the present document.

Where a detail (or enlarged) view is referred to, it is either taken from the area to which it's leading line points or from the inscribed circle correspondingly labelled.

For instance, in FIG. 1, Detail A shows an enlarged view of features 1133-1135 as inscribed by the circle in the broader view of FIG. 1. Similarly, in FIG. 3, there is a circle having a “B” next to it. The contents of that circle are enlarged in Detail B directly therebelow.

FIG. 1 shows a perspective view of a transfer chair.

Detail A of FIG. 1 shows an enlarged view of a portion of the transfer chair of FIG. 1.

FIG. 2 shows a perspective view of a transfer chair.

Detail Q of FIG. 2 shows an enlarged view of a portion of the transfer chair of FIG. 2.

FIG. 3 shows a rear perspective view of a transfer chair in a first configuration.

Detail B of FIG. 3 shows an enlarged perspective view of a portion of the transfer chair of FIG. 3.

FIG. 4 shows a perspective view of a seat back.

FIG. 5 shows a perspective view of a transfer chair in the process of aiding a patient's egress from an automobile.

FIG. 6 shows a perspective view of a transfer chair in the process of aiding a patient's egress from an automobile.

FIG. 7 shows a perspective view of a transfer chair in the process of aiding a patient's egress from an automobile.

FIG. 8 shows a perspective view of a transfer chair in a second configuration.

Detail C of FIG. 8 shows an enlarged view of a portion of the transfer chair of FIG. 8.

FIG. 9 shows a perspective view of a transfer chair in a third configuration.

FIG. 10 shows a perspective view of in a third configuration.

Detail D of FIG. 10 shows an enlarged view of a portion of the transfer chair of FIG. 10.

FIG. 11 shows a perspective view of a frame of a transfer chair.

Detail M and Detail N of FIG. 11 shows enlarged views of portions of FIG. 11.

FIG. 12 shows a perspective view of a frame of a transfer chair.

Detail O and Detail P of FIG. 12 show enlarged views of portions of FIG. 12.

FIG. 13 shows a perspective view of a transfer chair in a first configuration.

Detail E and Detail F of FIG. 13 show enlarged views of portions of FIG. 13.

FIG. 14 shows a perspective view of the transfer chair of FIG. 13 in a second configuration.

FIG. 15 shows a perspective view of the transfer chair of FIG. 13 in a third configuration.

FIG. 16 shows a perspective view of a transfer chair.

Detail G of FIG. 16 shows an enlarged view of a portion of FIG. 16.

FIG. 17a shows a perspective view of a pin.

FIG. 17b shows a perspective view of a carriage.

FIG. 18 shows a perspective view of a transfer chair in a first configuration.

FIG. 19 shows a perspective view of a seat back.

Detail L of FIG. 19 shows an enlarged view of a portion of FIG. 19.

FIG. 20 shows a perspective view of the transfer chair of FIG. 18 in a second configuration.

FIG. 21 shows a perspective view of the transfer chair of FIG. 18 in a third configuration.

Detail H of FIG. 21 shows an enlarged perspective view of a portion of FIG. 21.

FIG. 22 shows a perspective view of the transfer chair of FIG. 18 in a fourth configuration.

FIG. 23 shows a perspective view of a clip.

FIG. 24 shows a perspective view of a transfer chair in a fourth configuration.

FIG. 25 shows perspective views of various components of the transfer chair of FIG. 24.

FIG. 26 shows a perspective view of a seat.

Detail R of FIG. 26 shows an enlarged perspective view of a portion of FIG. 26.

FIG. 27 shows perspective views of various elements of a seat back.

Detail S and Detail T show enlarged views of portions of FIG. 27.

FIG. 28 shows a perspective view of the transfer chair of FIG. 24 in a first configuration.

FIG. 29 shows a perspective view of the transfer chair of FIG. 24 in a second configuration.

FIG. 30 shows a perspective view of the transfer chair of FIG. 24 in a third configuration.

FIG. 31 shows a perspective view of a strap.

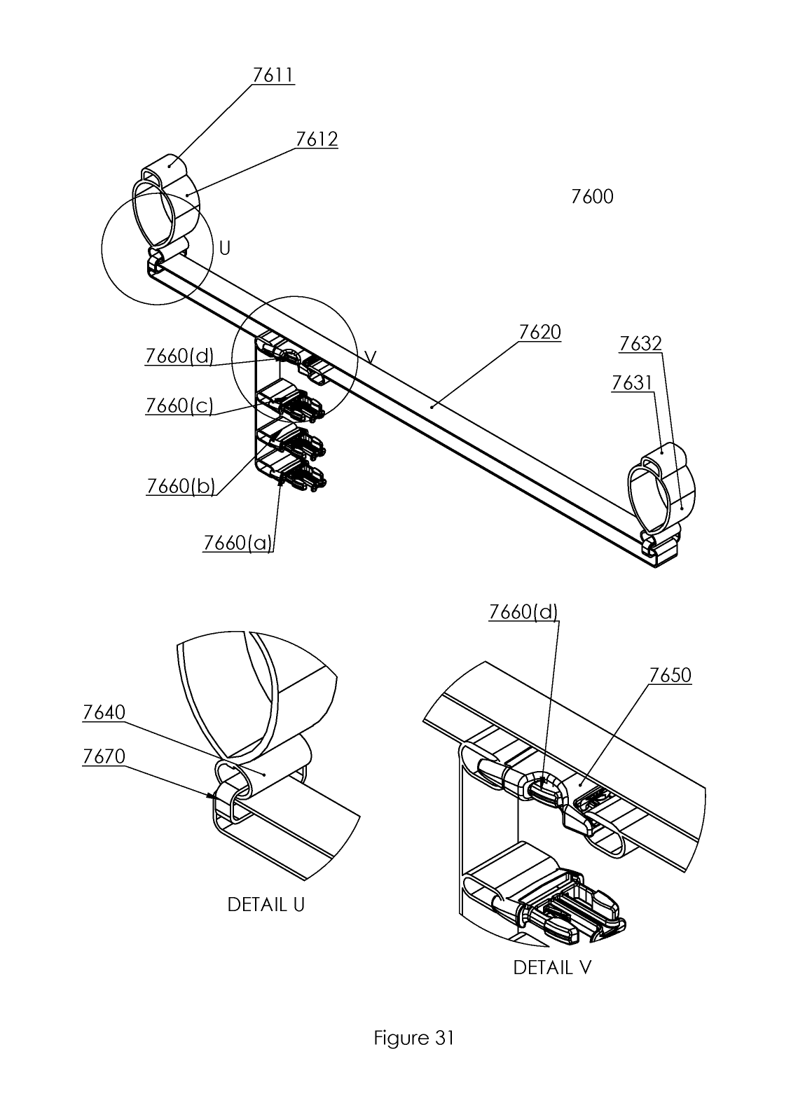

Detail U and Detail V of FIG. 31 show enlarged perspective views portions of FIG. 31.

### DETAILED DESCRIPTION OF THE FIGURES

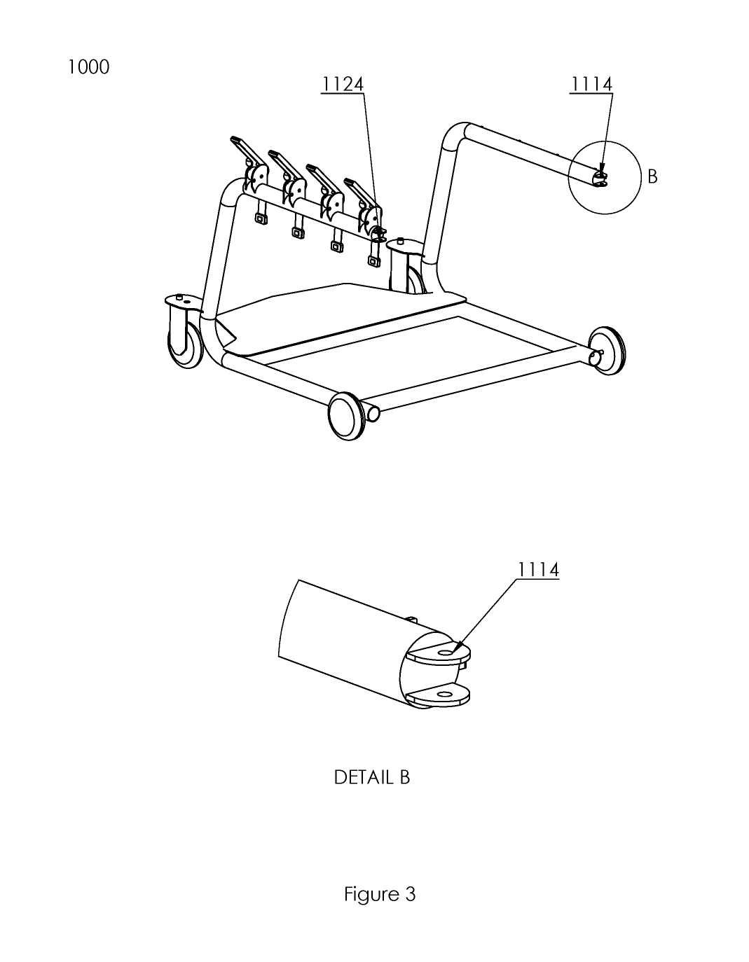

Various embodiments of the presently disclosed apparatus will now be described in detail with reference to the drawings, wherein like reference numerals identify similar or identical elements. In the drawings and in the description that follows, the term “proximal,” will refer to the end of a device or system that is closest to the operator, while the term “distal” will refer to the end of the device or system that is farthest from the operator. Similar, anatomical terms of reference such as dorsal, lateral, anterior, sagittal, dorsal, ventral, etc shall have their accepted meanings in the anatomical arts. Where multiple elements are denoted with a single callout numeral but multiple letters, the implication is that the numerals denote instances of similar structures. For instance lever assemblies 1130(a), 1130(b), and 1130(c) are repeating instances of structures having similar functions. Where “Detail” views are shown, the origin of the Detail view is denoted in a broader view with a circle defining the detail view and the letter of the view. For instance, in FIG. 3, the source Detail B is shown in the broader view as a Circle with a B next to it.

The various non-limiting embodiments described below provide an overall understanding of the principles of the structure, function, and use of the wheelchair devices disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of systems and methods for transporting an infirmed person from one surface to another and providing comfortable support. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

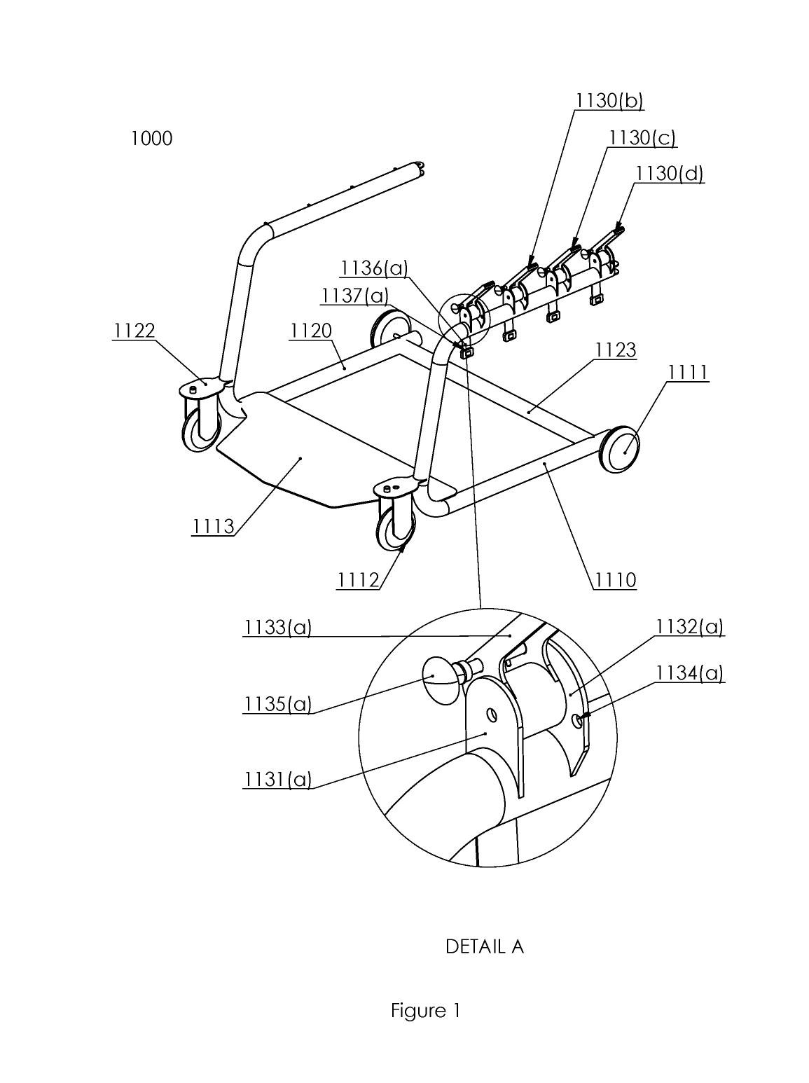

A first embodiment of a transfer chair 1000 is shown in FIG. 1, with a transfer chair 1000 being an improved invalid transport wheelchair having two opposed c-shaped frames 1110 and 1120 made from bent metal tubing with fixed wheels 1111 and 1121 and pivoting wheels 1112 and 1122 disposed thereupon with a foot rest 1113 and support bar 1123 coupling frames 1110 and 1120 at the respective anterior and posterior portions thereof. Referring now to detail A and FIG. 1 together, there are a plurality of lever assemblies 1130(a-d) disposed upon the dorsal end portion of frame 1110.

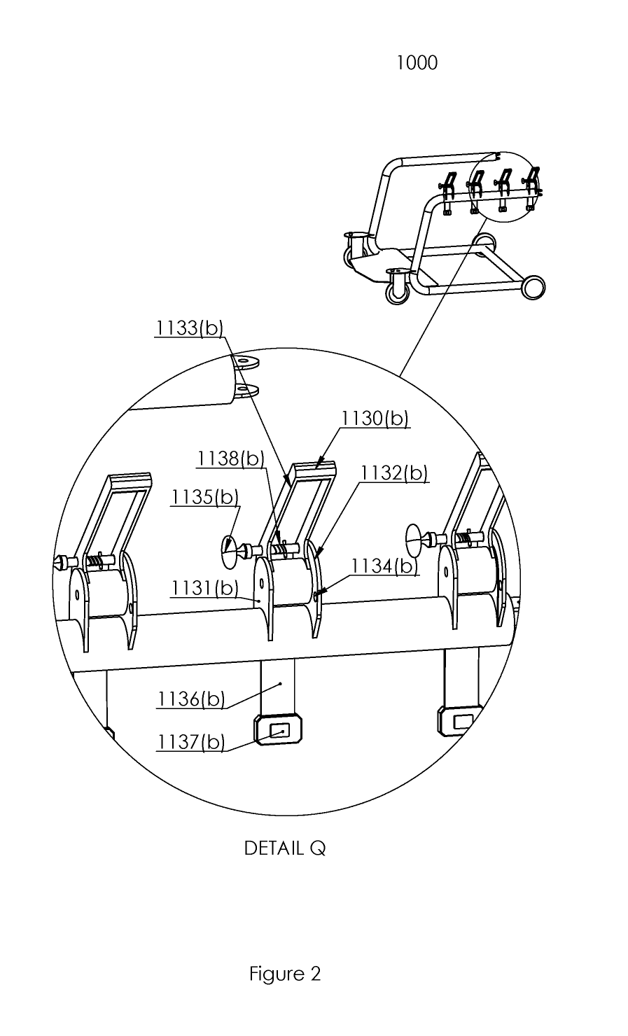

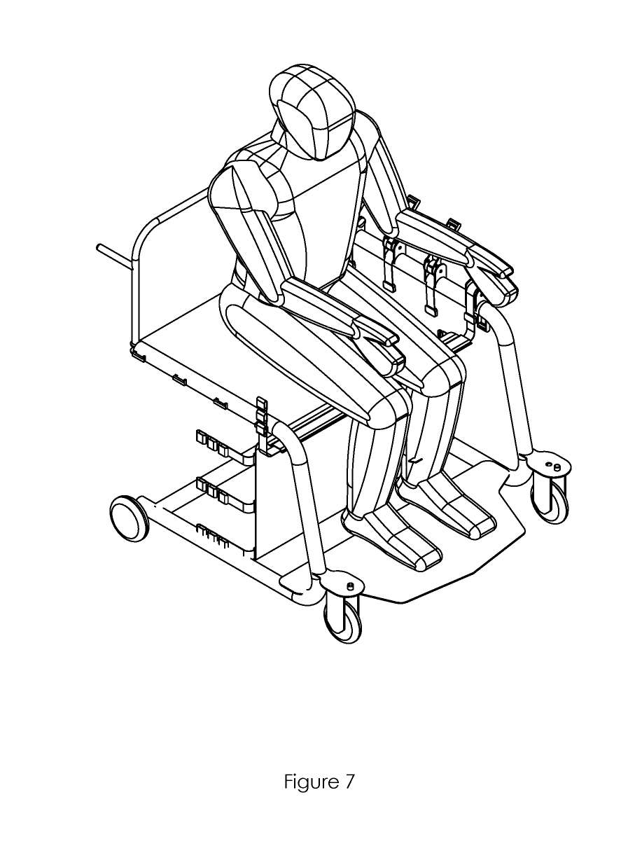

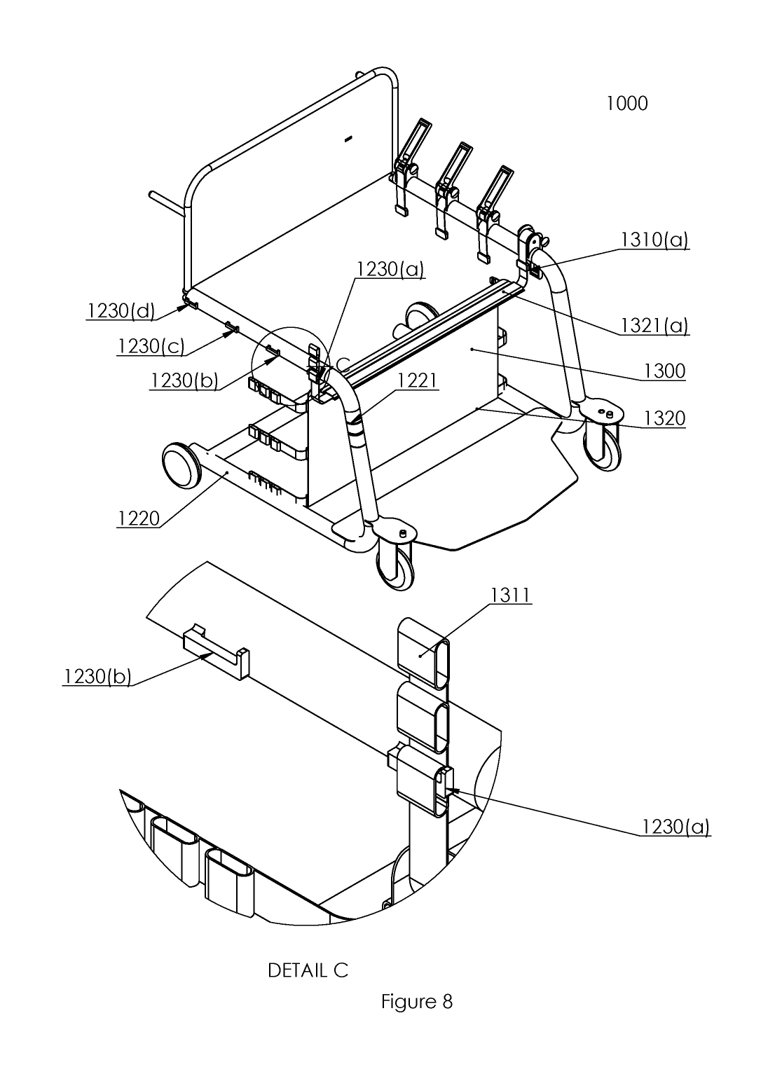

Referring now to FIGS. 1 and 2 together, each lever assembly 1130(a-d) has a fore-plate 1131(a-d) and aft-plate 1132(a-d). The fore-plate 1131(a-d) is a plate welded to frame 1110 and having an aperture extending therethrough. The aft-plate 1132(a-d) has a first aperture in concentric relation to the aperture of fore-plate 1131(a-d) and a second aperture 1134(a-d) sized and shaped to receive a pin 1135(a-d) therewithin. There is a swing-arm 1133(a-d) pivotably coupled about the aperture common to foreplate 1131(a-d) and aft-plate 1132(a-d) with a portion of webbing 1136(a-d) hanging down therefrom and terminating in a buckle 1137(a-d). Buckle 1137(a-d) may be an automotive, airline, slide release, or other style of buckle known in the arts. There is a pin 1135(a-d) slideably coupled to each arm 1133(a-d), with each pin having a first end with a handle disposed thereupon and a second end with a tip disposed thereupon. There is a spring 1138(a-d) [not shown] disposed within the assembly about pin 1135(a-d) which urges the tip towards aft-plate 1132. Webbing 1136 and buckle 1137(a-d) are coupled to the swing-arm 1133(a-d) generally about its axis of rotation such that when swing arm is in a first, “open” condition as shown in FIG. 1, the buckle is closer to the ground while in a second “closed” condition as shown in FIGS. 7 and 8, the buckle is further from the ground and the tip of pin 1135(a-d) extends into aperture 1134(a-d).

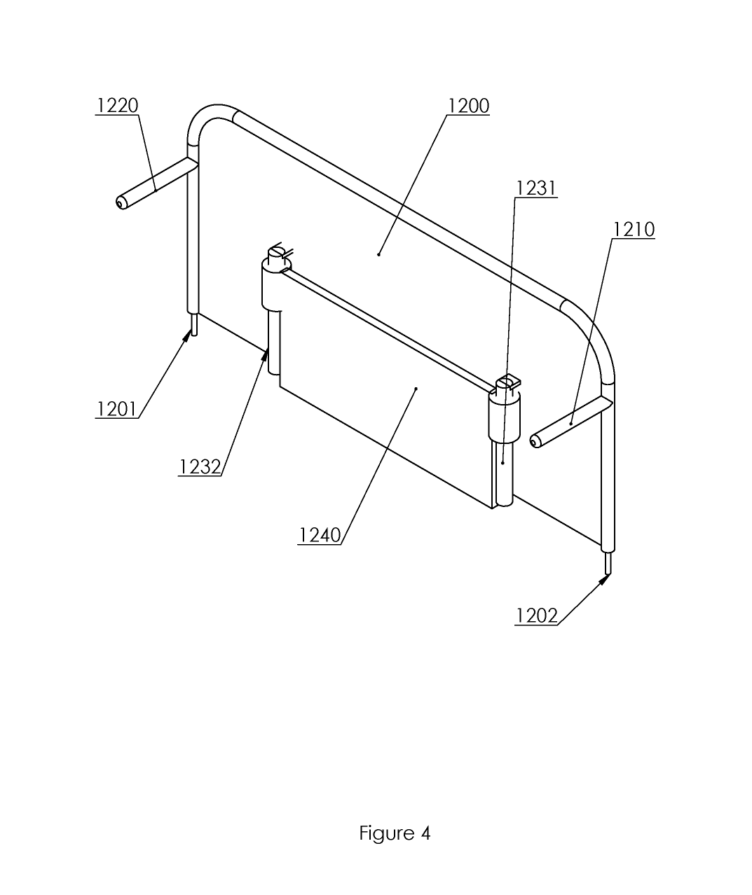

Referring now to FIG. 3, the posterior end portions of frames 1110 and 1120 are shown, with each end portion having couplers 1114 and 1124 disposed thereupon. Couplers 1114 and 1124 comprise a pair of rigid plates having apertures extending therethrough sized and shaped to receive a complementary pin 1201 and 1202 therewithin with the pin being coupled to a seat back 1200 as shown in FIG. 4. There are further embodiments of the present disclosure where a seat-back has a “swinging” configuration as shown in Body Up Manual™ included with the present application. The entire Body Up Manual is hereby incorporated by reference in its entirety.

Referring now to FIG. 4, a seat back 1200 is a generally rigid member having two pins 1201 and 1202 extending generally downward therefrom, with the pins being sized and shaped to be insertable into couplers 1114 and 1124 disposed upon frames 1110 and 1120. There are two handles 1210 and 1220 disposed upon opposing sides of the seat back and extending in a posterior direction therefrom. There are a pair of vertical rails 1231 and 1232 disposed upon the posterior face of the seat-back with a secondary back 1240 slideably coupled to the rails 1231 and 1231 so that the bottom edge of the secondary seat back 1240 may be positioned up or down relative to the remainder of the assembly in order to minimize the gap between the surface of the car seat and the bottom edge of the seat back 1240.

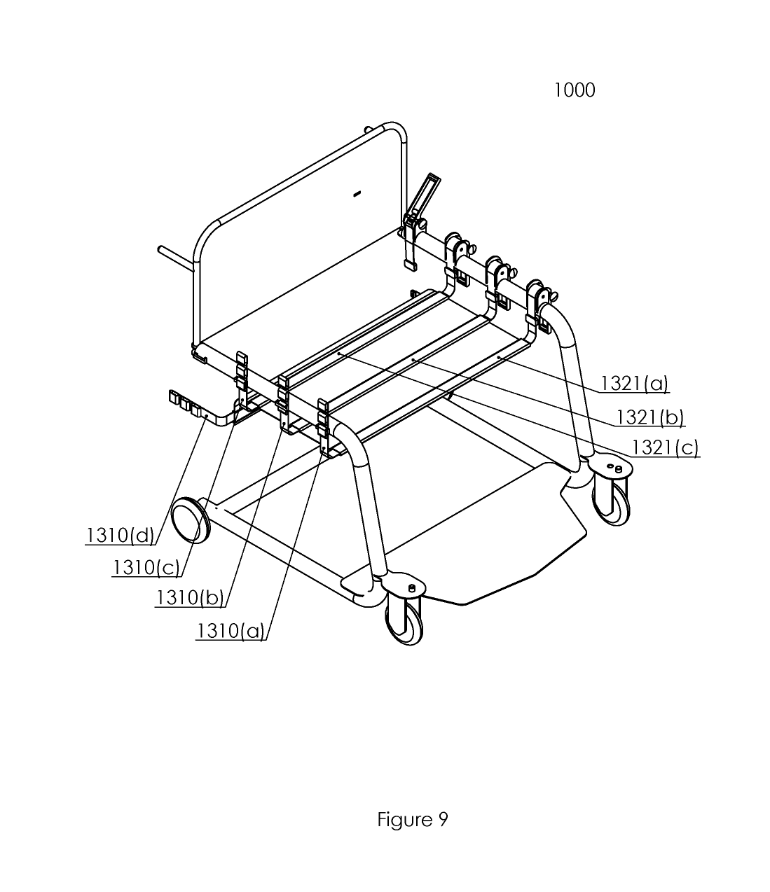

Referring now to FIGS. 8 and 9, a transfer chair 1000 has a seat 1300, with the seat comprising a flexible pad 1320 with a plurality of channels 1321(a-d) extending laterally therethrough. There is a strap 1310(a-d) extending slideably through each respective channel 1321(a-d). According to the embodiment of the present disclosure shown in the Figures, each strap 1310(a-d) can slide left to right within each channel 1321(a-d). According to further embodiments of the present disclosure, straps are fixed left-to-right relative to the seats. At a first end of each strap 1310(a-d), there is a series of loops 1311 which are sized and shaped to be engaged upon a respective hanger 1230(a-d), with each hanger 1230(a-d) coupled to frame 1120. According to further embodiments of the present disclosure, there are one or more rigid inserts including for example a strip of molded nylon or aluminum running laterally (in parallel with the channels 1310(a-d)) through seat 1300 so that the seat is generally flexible front-to-back but generally rigid left-to-right.

According to certain embodiments of the present disclosure, including the embodiment shown in FIG. 8, there are gradation marks 1221 disposed upon one of the frames 1110 or 1120 which are visually or color coded to the loops 1311 so that when the device is positioned near a car seat, said marks provide a guide for the operator as to the appropriate loop 1311 for setting the resultant seat height.

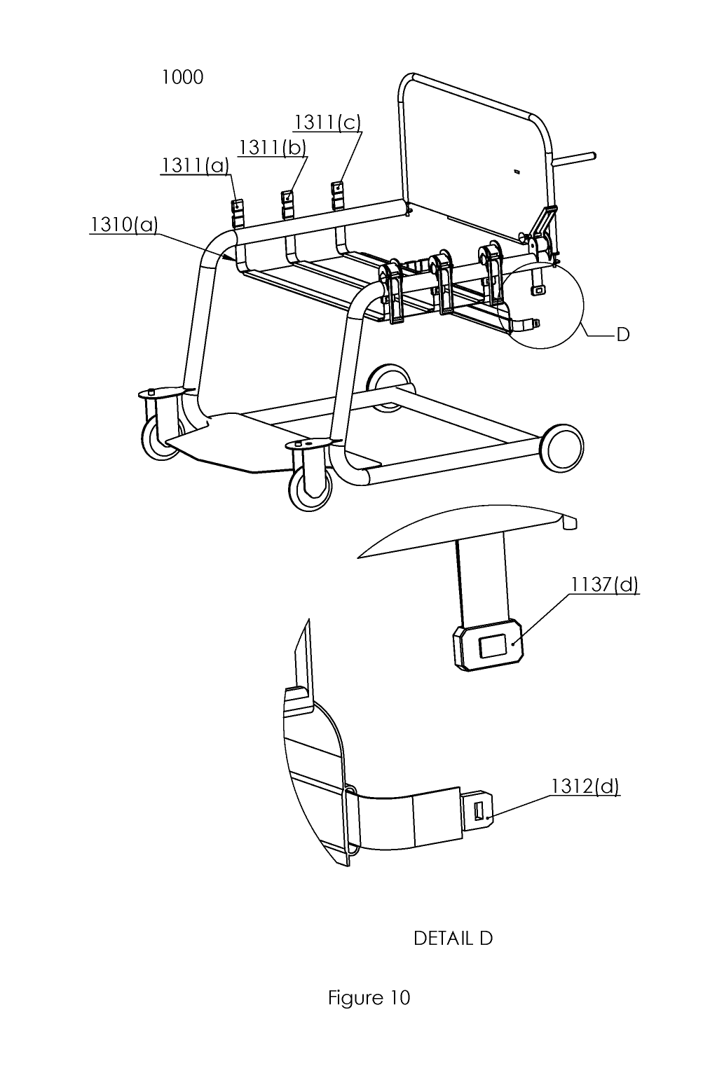

Referring now to FIG. 10, each strap 1310(a-d) has a male coupler 1312(a-d) disposed on an end thereof which is complementary to the buckle(s) 1137(a-d).

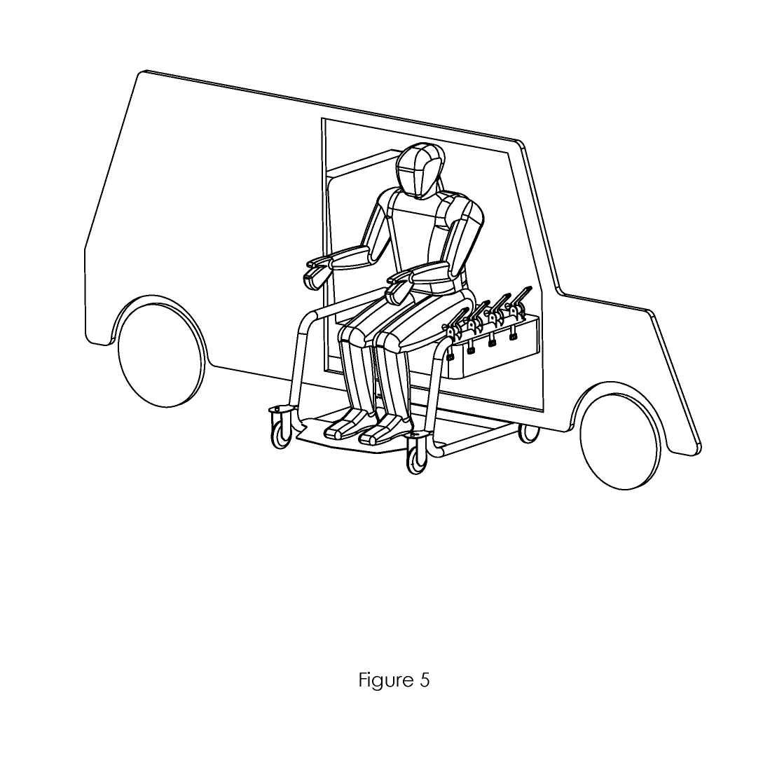

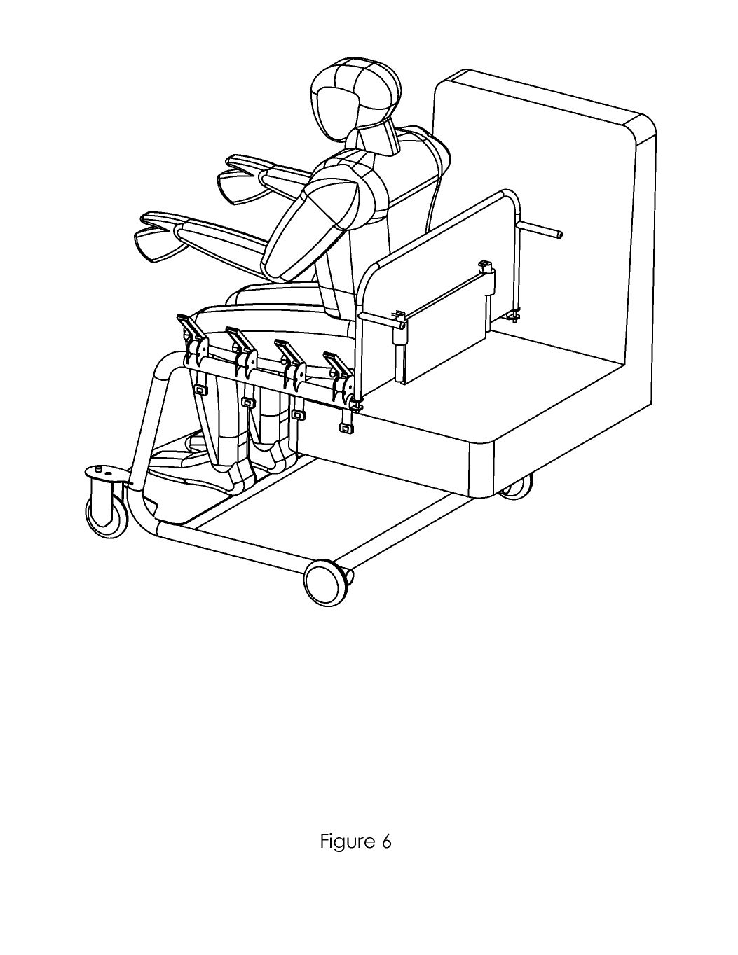

A method of using a transfer chair 1000 will now be described with reference to FIGS. 1-10. A transfer chair is initially provided in a first configuration, as shown in FIG. 1, with the seat 1300 and seat back 1200 removed. A patient who desires to be removed from a motor vehicle is positioned as shown in FIG. 5, facing out the car door seated in the passenger seat of a car. Next, the assembly is positioned by an operator as shown in FIGS. 5 and 6, so that the dorsal end portions of the device extend along the left and right sides of the patient's torso. Next, the seat back 1200 is attached as shown in FIG. 6 by inserting pins 1202 and 1201 into couplers 1114 and 1124 and then positioning the secondary back 1240 so that its ventral edge is as close as possible to the surface of the car seat. Next, an operator attaches the anterior-most strap 1310(a) of seat 1300 by selecting the appropriate loop 1311 to the first hanger 1230(a) so that the resultant height of the seating surface is as close to that of the automobile seat and strap 1310(a) is disposed just below the bend of the patient's knee. Next, the operator clips the male coupler 1312(a) into buckle 1137(a) and translates the lever 1130(a) downward into its “closed” condition, thereby wrapping webbing 1136(a) about the axis of swing-arm 1133(a) and lifting the patient's legs up into a configuration as shown in FIGS. 7 and 8. Next, the operator slides the patient away from the car only enough to repeat the procedure with subsequent lever assembly 1130(b), followed by lever assembly 1130(c) into a configuration as shown in FIGS. 9 and 10, and finally 1130(d) at which point the patient has been safely removed from the automobile and onto the seating surface of the transfer chair. In order to reverse the process and transfer a user from the present invention to an automobile seat, the aforementioned process may be generally reversed.

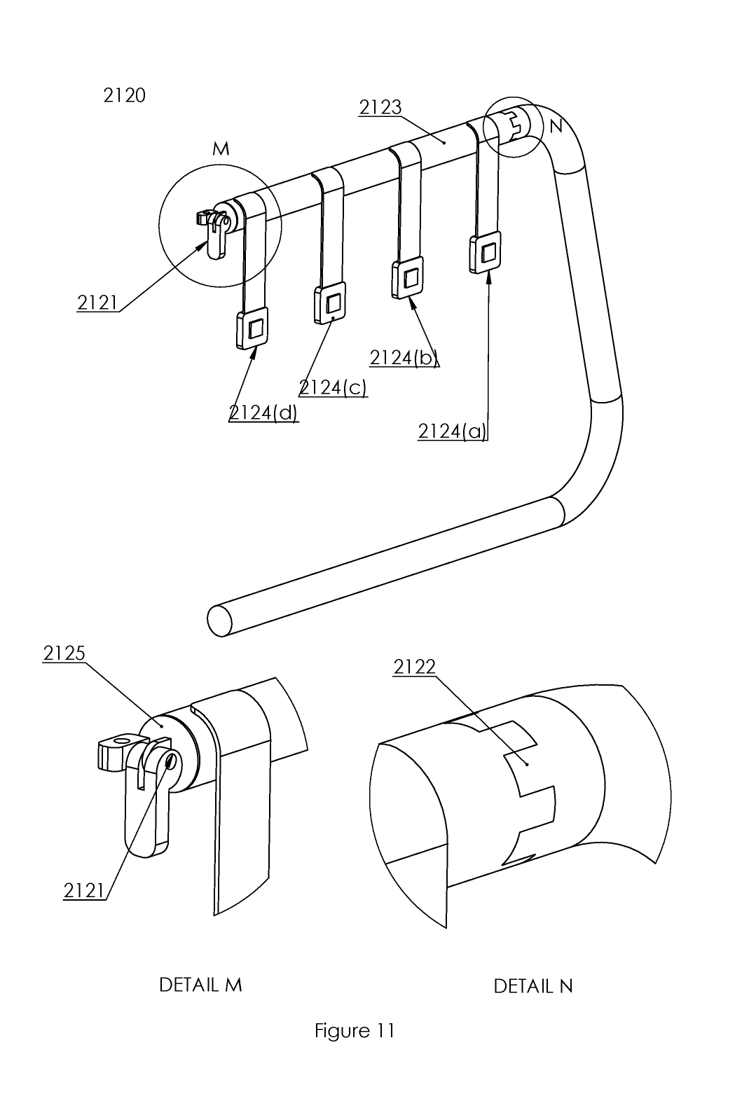

Referring to FIG. 11, an further embodiment of frame 1120 is shown as frame 2120. For the sake of simplicity, remaining structures such as wheels, and the opposing frame 1110 have been omitted from the Figure. In this embodiment the strap length adjustment previously achieved by loops 1311 and hanger 1230(a-d) is achieved by means of a rotating sleeve 2133. Sleeve 2133 is a portion of tubing having a long axis which is capable of rotating about frame 2120 along said long axis. There is a gear 2122 cut into a first end of sleeve 2133 with a complementary gear cut into frame 2120. There are a plurality of straps 2124(a-d) coupled to sleeve 2133 at a first end of the straps and having a buckle at the second end of each strap. Each buckle has a complementary coupler disposed upon the seating surface. There is an eccentric cam lever 2121 similar in operation to quick release levers used on bicycle eats disposed upon the second end of sleeve 2133. Cam lever 2121 acts upon a late 2125 which in turn urges sleeve 2133 in an anterior direction, engaging the complementary portions of gear 2122.

If an operator seeks to change the effective height of the seating surface, they can translate the lever 2121 upward, thereby disengaging it and plate 2125 and allowing sleeve 2133 to be translated in a posterior direction relative to the frame 2120, thereby disengaging the gear 2122 and allowing the sleeve 2133 to be spun about its axis either wrapping each strap 2124(a-d) about the sleeve, thereby raising each buckle or unwrapping each strap, thereby lowering each buckle. Once an operator achieves their desired height, the cam 2121 is translated downward, thereby re-engaging the complementary portions of gear 2122 and fixing the sleeve relative to the frame.

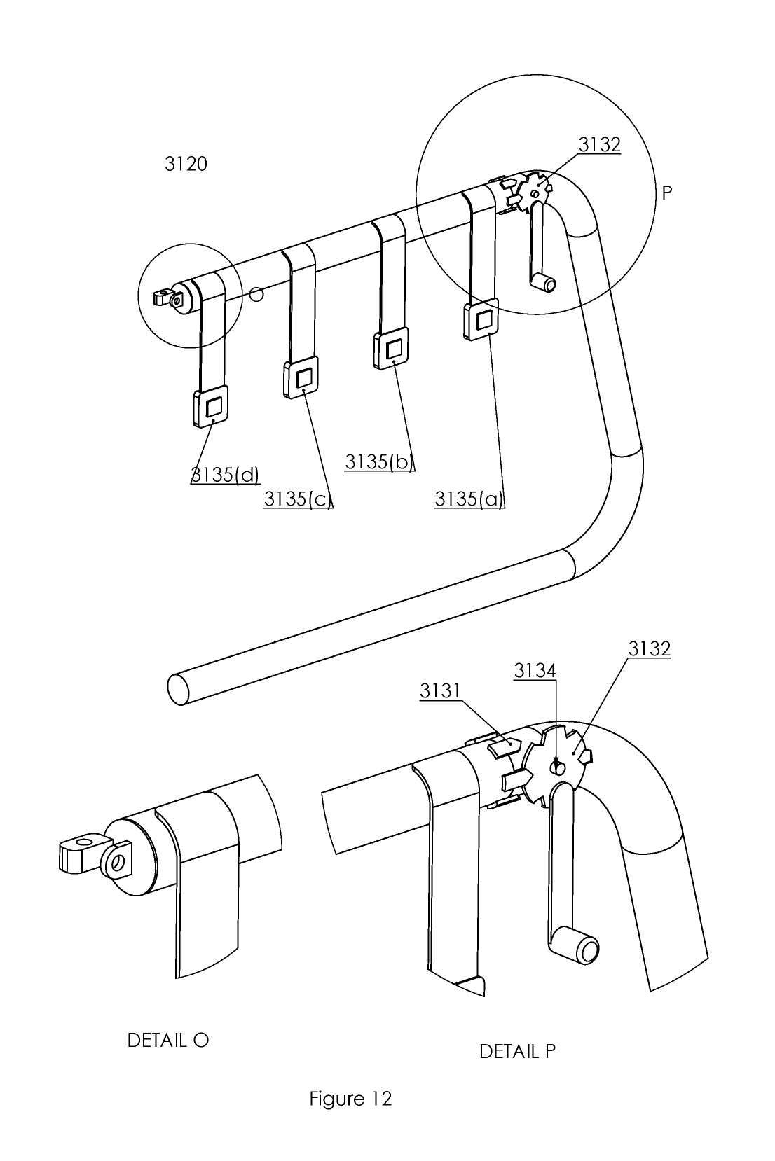

Referring now to FIG. 12, a related embodiment 3120 of a frame is shown, wherein a sleeve 3133 can rotate about its long axis relative to frame 3120 and has a rotary gear 3131 at a first end thereof. The gear 3131 is engaged upon a geared crank 3132, with the crank being rotably coupled to frame 3120, such that rotation of the crank 3132 about its axis 3134 turns gear 3131, thereby raising or lowering the height of buckles 3135(a-d) relative to the remainder of the assembly. There are further embodiments of the present disclosure wherein crank 3132 is driven by an electric motor including for example a geared DC motor, stepper motor, or servo.

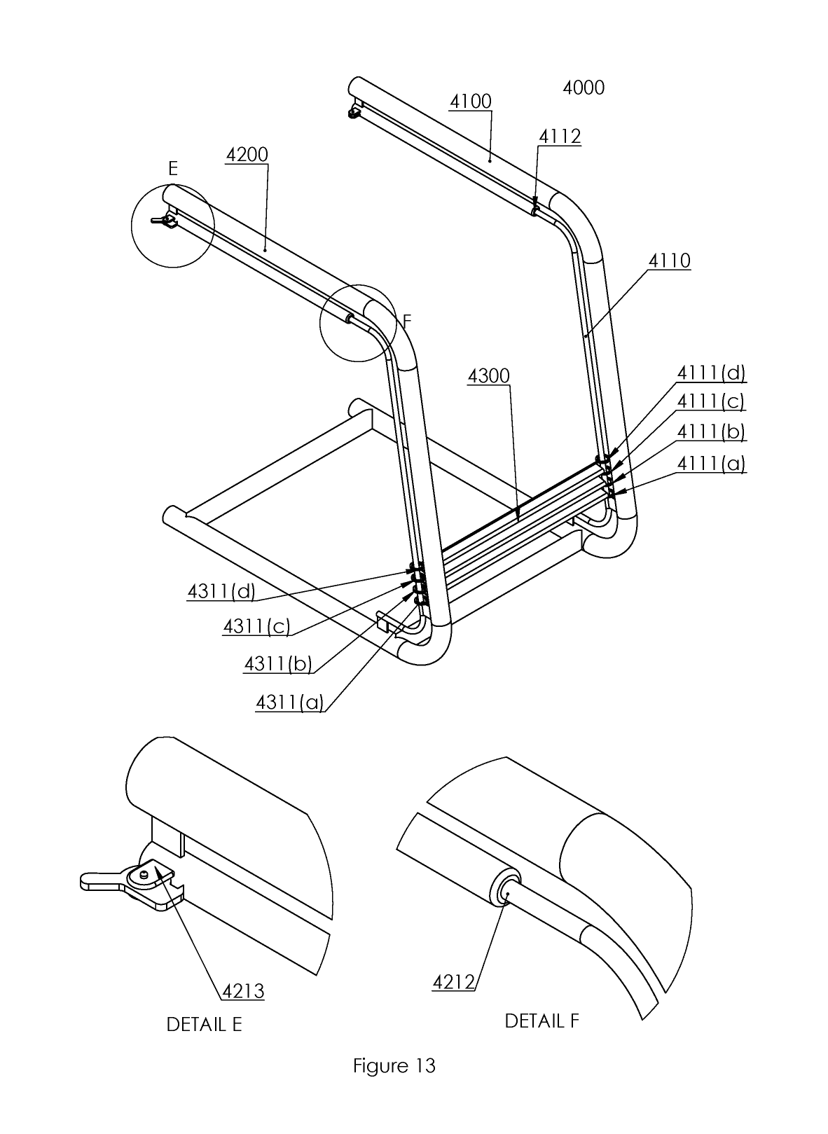

Referring now to FIG. 13, a further embodiment 4000 of a transfer chair is shown. In this embodiment the wheels, a footrest, and seatback have been omitted as they are substantially similar in function to those shown in embodiment 1000. Transfer chair 1000 has a pair of opposing frames 4100 and 4200, with each frame having a guide rail 4110 and 4210 attached thereto. Each rail has a spring loaded clip 4213 disposed near the posterior end thereof and a shelf 4212 and 4112 at an upper anterior portion thereof, with the shelf 4211 defining a change in the diameter of each rail. Each clip 4213 has an anterior facing tooth portion and a posterior facing thumb-lever. The clip is biased such that the tooth is urged against the rail unless the thumb-lever is depressed. There is a clip similar to 4213 disposed at the end of frame 4100, but it is obscured by the present view. There is a flexible seating surface 4300 slideably coupled to each rail by means of a plurality of rings 4311(a-d) and 4111(a-d). The inner diameter of the first rings 4311(a) and 4111(a) is smaller than the others so that it cannot move past shelf 4212 and 4112. The shape of the last rings 4311(d) and 4111(d) is complementary to that of the tooth upon the clip 4213 and the obscured clip so that each ring may be engaged by the tooth of said clip(s).

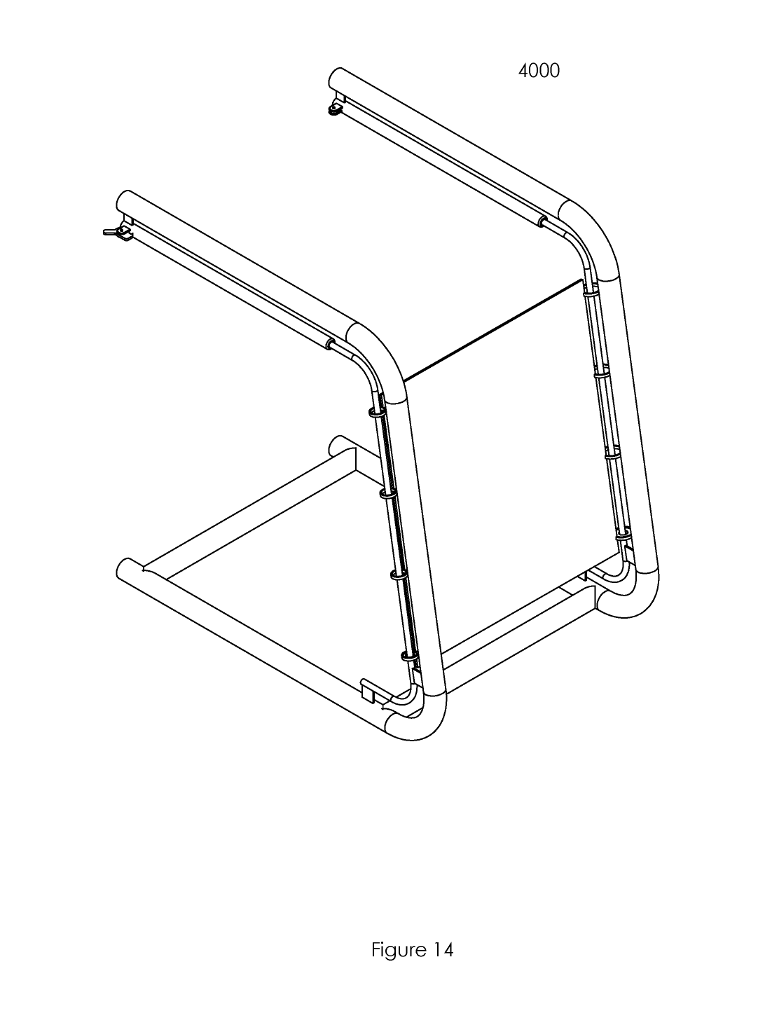

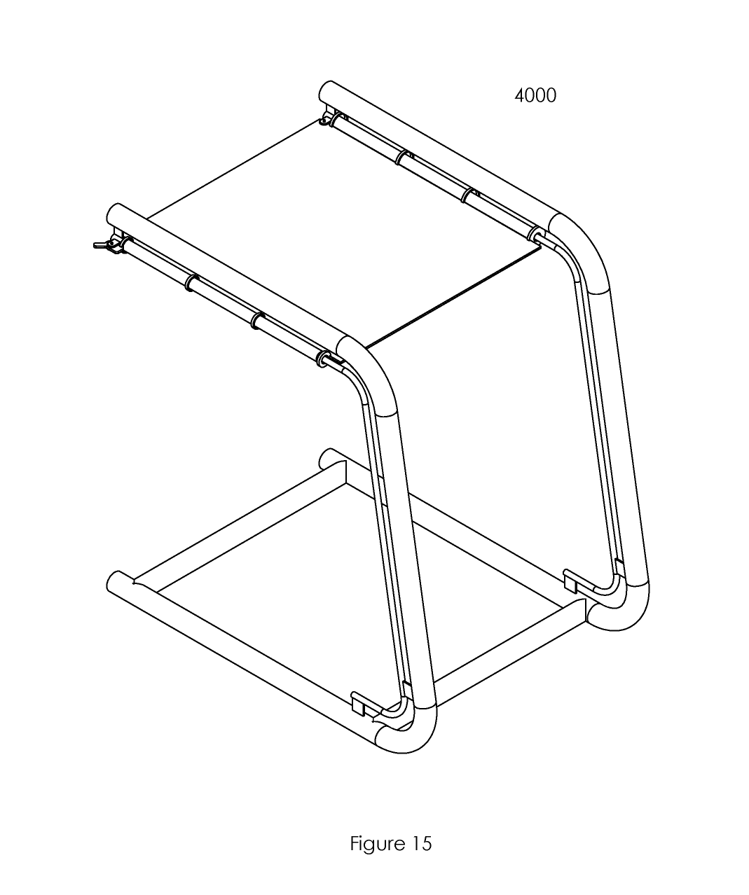

A method of using the embodiment 4000 of a transfer chair as shown in FIGS. 13, 14, and 15 will now be described. Initially, a transfer chair 4000 is provided in a first configuration as shown in FIG. 13. A patient is placed facing out of a car door as previously demonstrated in FIG. 5 with the patient's feet facing out the car door. An operator moves the transfer chair 4000 towards the patient and raises the patient's feet up and over seat 4300 so that the seat is between the patient's legs and the car. Next, the operator slides the seat up along the guide rails 4110 and 4210 as shown in FIG. 14 and incrementally urges the patient away from the car's seat and onto the seat 4300 until the transfer chair is configured as shown in FIG. 15, with clip 4123 and a similar (but obscured) clip on the other side of the device engaged upon rings 4311(d) and 4111(d) and the seating surface pulled relatively taut under a patient.

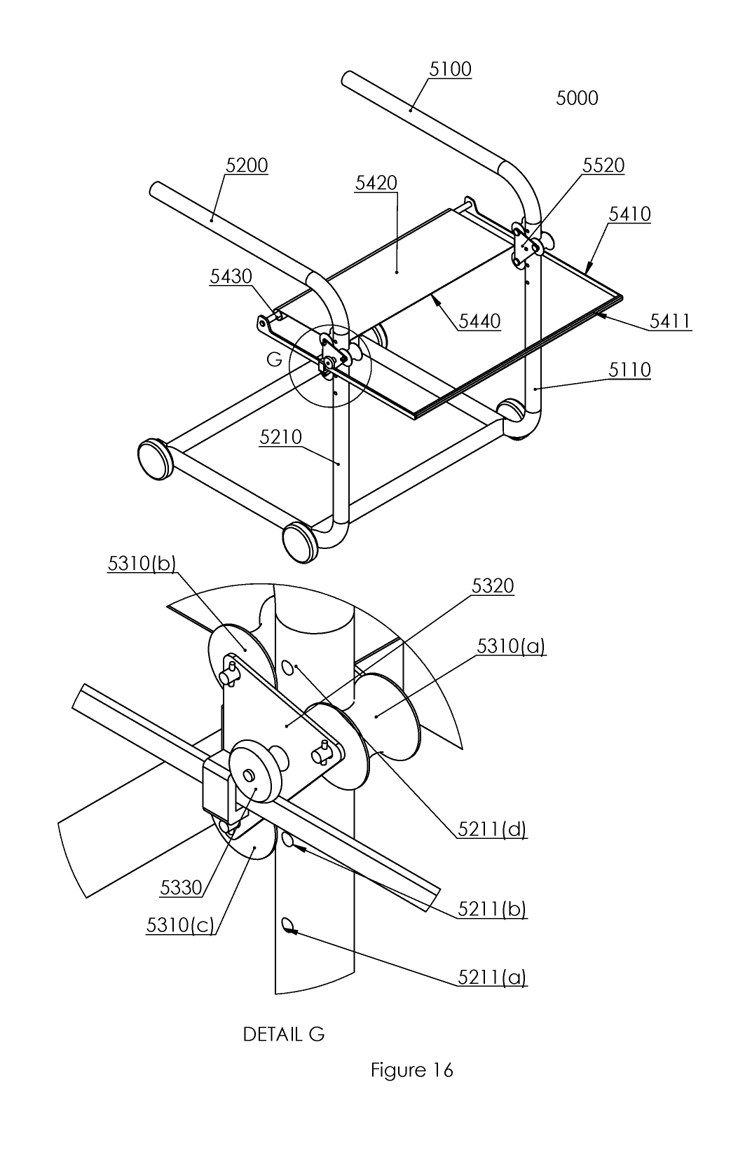

Referring now to FIG. 16, a further embodiment 5000 of a transfer chair is shown. Transfer chair 5000 has a pair of opposing frames 5100 and 5200, with each frame having a generally straight portion 5110 and 5210 along a mid-section thereof. There are a plurality of apertures 5211(a-d) upon portion 5210 upon which a pin 5330 may be engaged. There are wheels 5310(a-c) coupled to a carriage 5320 which ride along section 5210. There is a carriage 5520 opposite from carriage 5320 which substantially mirrors the features of carriage 5520 and has similar wheels which ride along section 5110. A drawer 5410 is slideably coupled to the carriage 5320 and 5520 with a rigid beam 5440 extending therebetween. Drawer 5410 has a lateral bar 5411 at a anterior end thereof and a spooled seat 5430 coupled to the posterior end of the drawer 5410. The spooled seat is similar mechanically to a pull-down window blind or projection screen in that it is a rigid, spring-loaded roll of material. Its leading edge 5540 is coupled to carriage 5520 and 5220 and its spooled seat 5430 is coupled to the posterior end portion of drawer 5410. The overall length of material on the roller is such that it is fully extended and cannot unroll any further when the drawer 5410 is translated completely posteriorly relative to the remainder of the assembly. According to certain embodiments of the present disclosure, leading edge 5540 is rigid.¬¬

In use, the drawer is configurable in three conditions, a first, “wrapped” condition, where the lateral bar 5411 is translated as far in an anterior direction as the assembly will allow and the spring within spooled seat 5430 takes up most of the material of the seating surface 5420 onto the roller thereby minimizing the surface area of the seat. There is a second, “unwrapped” condition, where the lateral bar 5411 is translated as far in a posterior direction as the assembly will allow, and the seating surface 5420 is fully unrolled and at its mechanical end or stop maximizing the surface area of the seat. There is a third, intermediate condition as shown in FIG. 16, in which the seating surface is partially deployed and partially spooled up onto the spooled seat 5420.

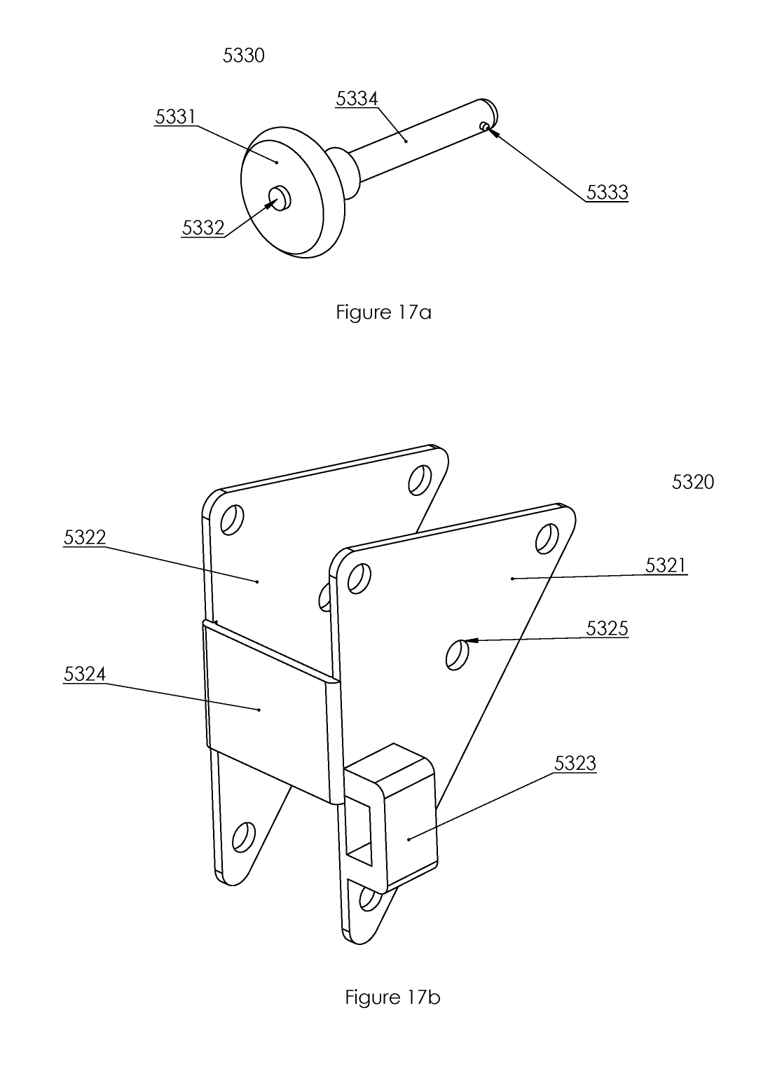

Referring now to FIG. 17a, a pin 5330 is shown, having an enlarged gripping portion 5331 with a push-button 5332 at the center thereof. When depressed, push button 5332 retracts a spring loaded barb 5433 at the end of a long shaft 5334 An exemplary embodiment of a pin 5330 is McMaster Carr® catalog number 90985A114, Knob-Grip Push-Button Quick-Release Pin ¼″ Diameter, 2″ Usable Length. Referring now to FIG. 17b, a carriage 5320 is shown. Carriage 5320 is a portion of bent sheet metal having a lateral plate 5321, a medial plate 5322, and a bridge 5324 therebetween. Plates 5322 and 5321 have a plurality of apertures extending therethrough sized and shaped to engage rollers 5310(a-c) engaged about a tube frame as previously discussed and shown. There is an aperture 5325 extending through the plates sized and shaped to couple the carriage(s) to apertures 5211(a-d) by means of pin 5330. There is a slide 5323 upon the lateral face 5321, with the slide 5323 having an elongated aperture extending therethrough along which drawer 5410 can slide. According to certain embodiments of the present disclosure, the interior faces of slide 5323 are coated with a friction-reducing bearing surface such as high molecular weight polyethylene or mechanical roller bearings. The size and shape of the slide 5323 is such that the rotational moment of the drawer 5410 as it sits in slide 5323 creates friction keeping the drawer in place. In order to translate the drawer relative to the slide, an operator must lift lateral bar 5411 slightly.

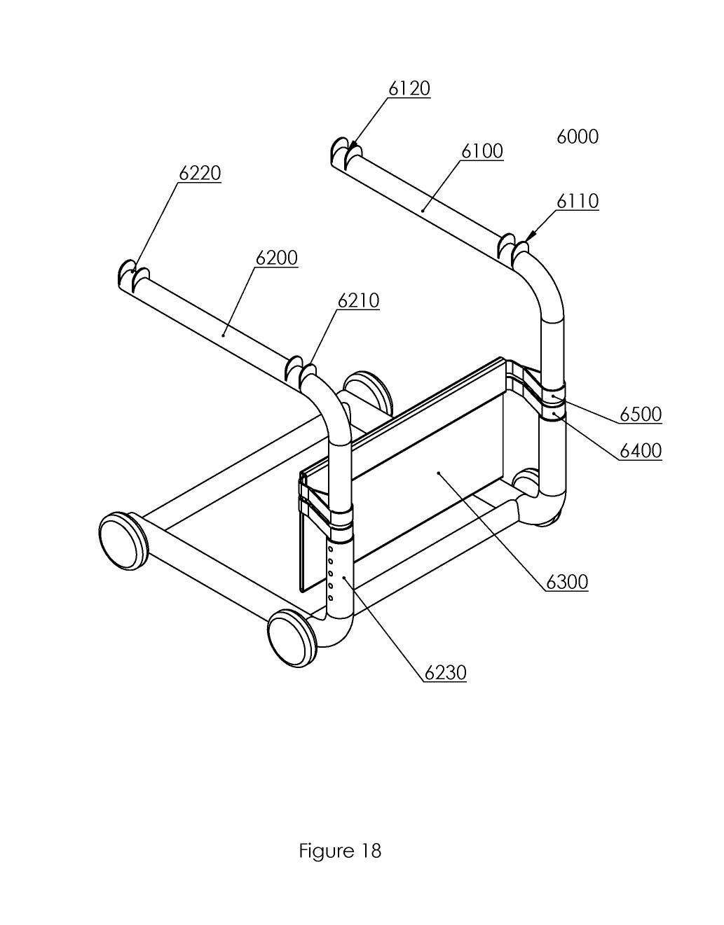

Referring now to FIG. 18, a further embodiment 6000 of a transfer chair is shown, with the transfer chair 6000 having a two generally c-shaped tubular frames 6100 and 6200, sliding straps 6400 and 6500 engaged about frames 6100 and 6200 and shaped to slideably move along frames 6100 and 6200, and a seating surface 6300 which is a looped portion of fabric defining a seating surface. There are protrusions 6110, 6210, 6120, and 6220 extending dorsally from the upper portion of frames 6100 and 6200 sized and shaped to capture straps 6400 and 6500. The length of the front portion of the frames 6100 and 6200 may be adjusted by a used by means of a plurality of holes 6230 which accommodate telescoping portions of tubing, with the lower portion having a larger diameter which accepts the smaller diameter upper portion therewithin. A pin may be inserted into the holes once the desired height is established by a user in a manner similar to telescoping canes and crutches well known in the medical arts.

There is a similar array of apertures disposed upon frame 6100 which is obscured by the perspective of the Figure and consequently not called out here.

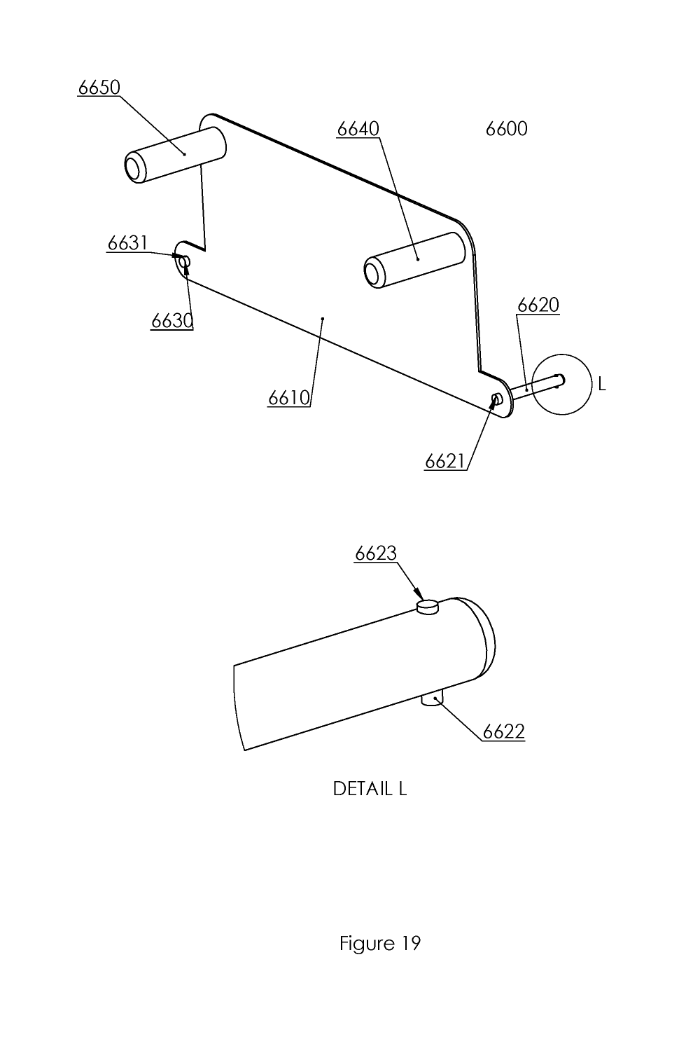

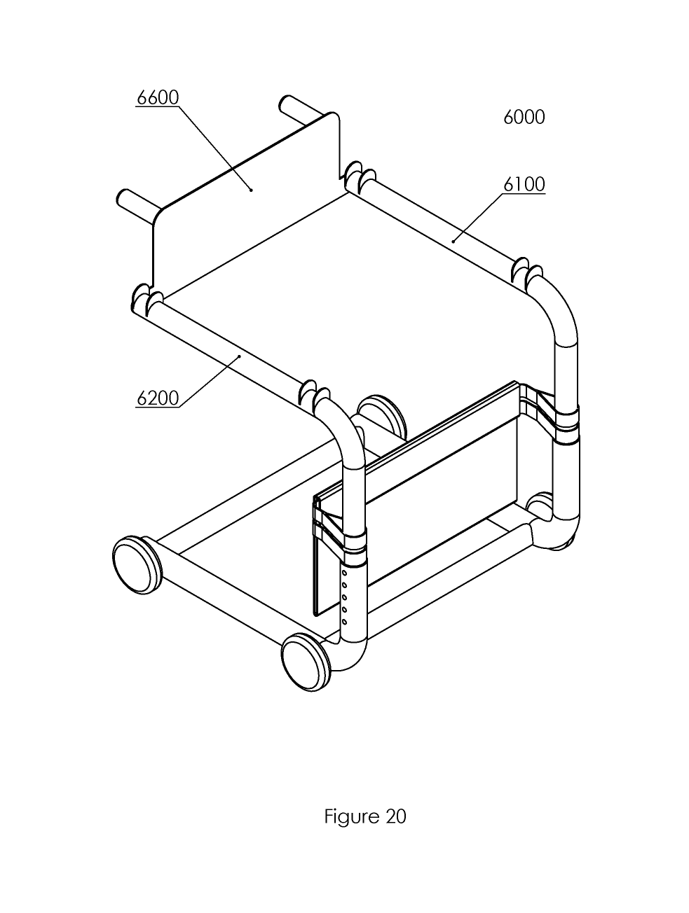

Referring now to FIGS. 19a and 19b together, a seat back 6600 is a removable back which may be coupled to frames 6100 and 6200 by means of pins 6621 and 6630 which are insertable into complementary recesses in the upper portion of frames 6100 and 6200. The anterior end portions of pins 6620 and 6630 have retractable pins 6623 and 6622 disposed thereupon which may be retracted by depressing a button 6621 and 6631 at the posterior face thereof. The operation of the retractable pins and button is substantially similar to that of pin 5330 described above. There are two hand grips 6650 and 6640 extending in a posterior direction from a back-plate 6610. A view of the seat back 6600 coupled to the remainder of the transfer chair 6000 can be seen in FIG. 20.

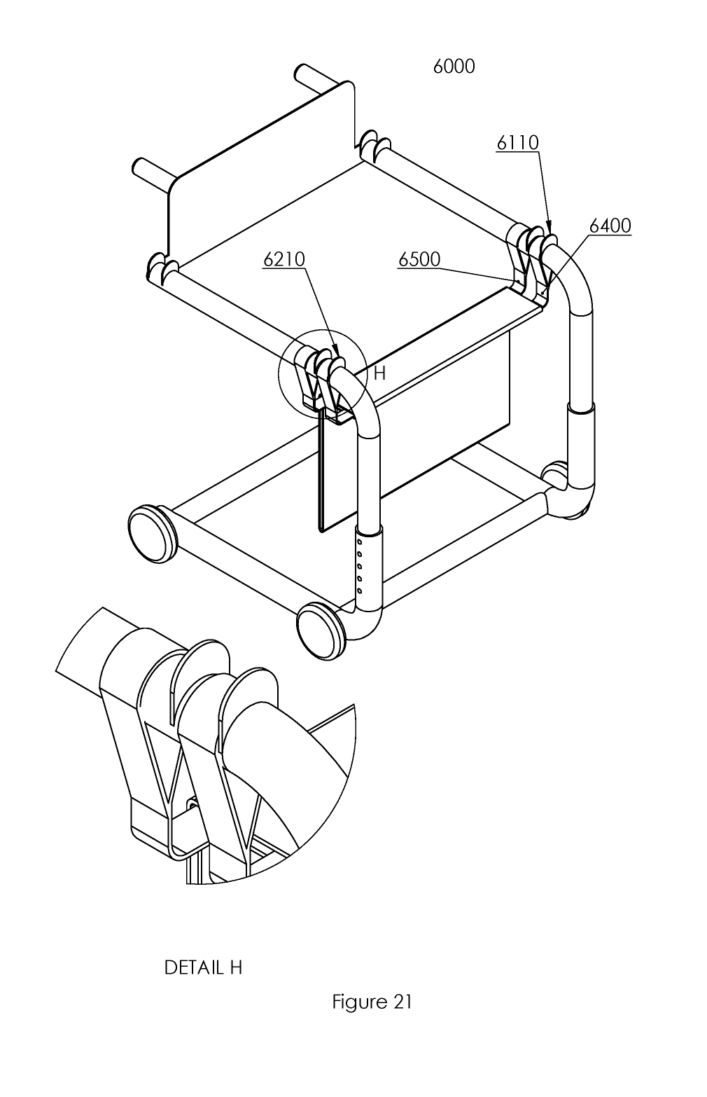

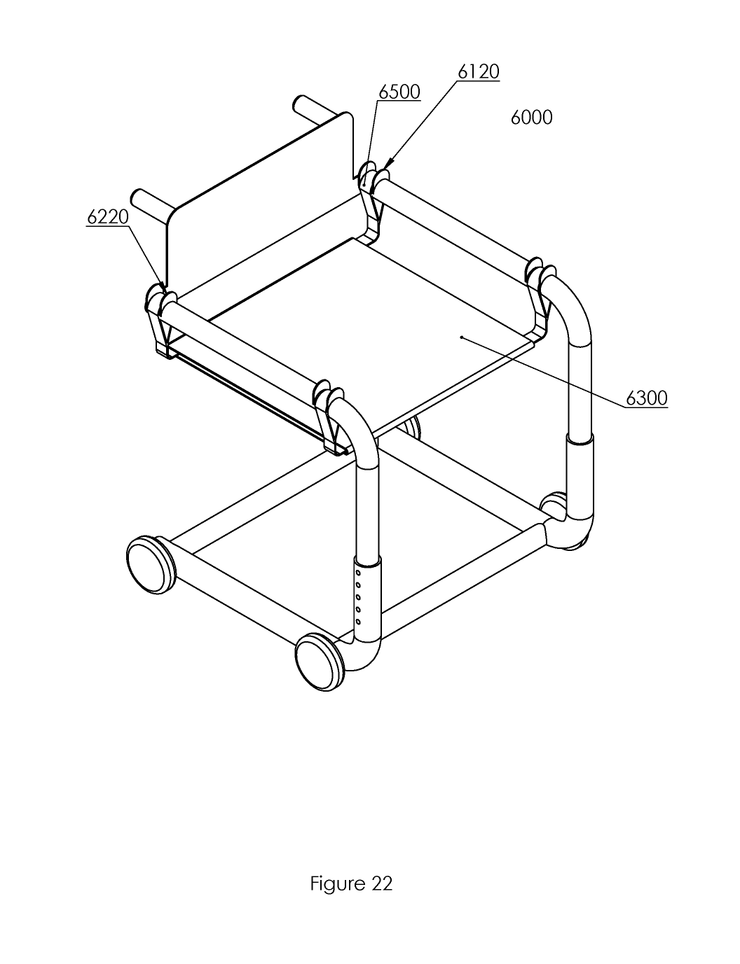

A method of using a transfer chair 6000 will now be described. Initially, the chair is provided in a first condition, as shown in FIG. 18, with the seating surface 6300, straps 6400 and 6500 positioned towards the ground, and the seat-back removed. This assembly is positioned around a patient who is sitting at the edge of a car seat with his feet pointed out the car door, in a manner similar to that of the patient in FIG. 5. As the assembly is moved towards the car, the patient is instructed to lift his feet up and over the seating surface 6300 and straps 6400 and 6500 such that the straps and seat are between the car and the patient's calves. Next, an operator connects the seat back 6600 to the frames 6100 and 6200 into a configuration as shown in FIG. 20, clicking pins 6623 and 6624 into complementary recesses in frames 6100 and 6200, thereby coupling the seat back to the frames. Next, the operator slides the straps up and over protrusions 6210 and 6110 so that strap 6500 is disposed posterior to the protrusions and strap 6400 is retained within protrusions 6110 and 6210. Such a configuration is shown in FIG. 21. In such a configuration, the seating surface 6300 is positioned under the bend of the patient's knee. Next, the transfer chair 6000 and patient are incrementally moved away from the car several inches at a time by an operator while the strap 6500 is incrementally translated towards to posterior end of the assembly as the wheelchair by the operator, until finally, the patient is away from the car and the transfer chair 6000 is configured as shown in FIG. 22, with strap 6500 engaged upon protrusions 6120 and 6220, and the loop of fabric that defines seating surface is pulled substantially taut.

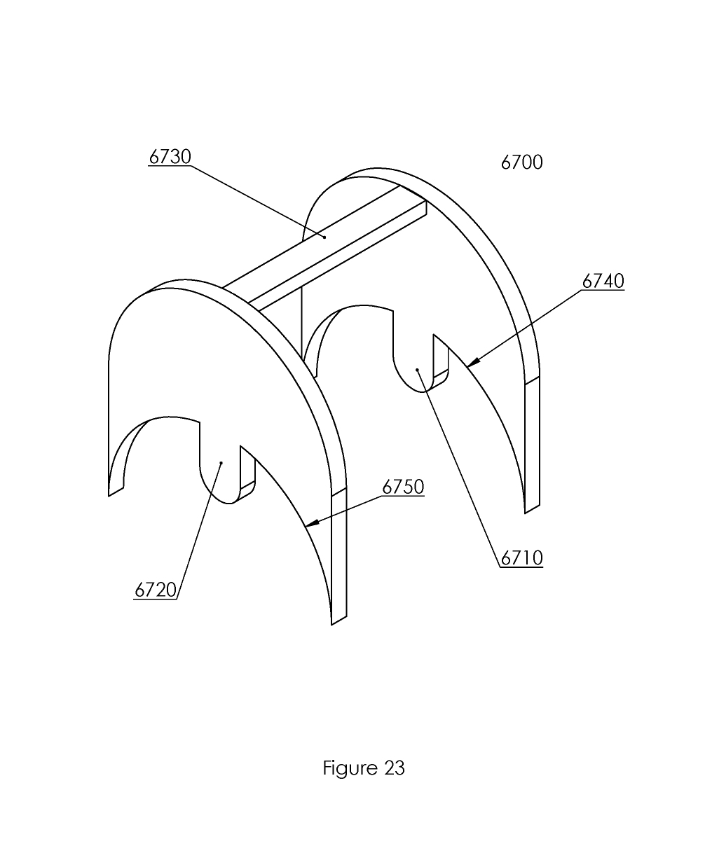

Referring now to FIG. 23, a clip 6700 is shown, wherein clip 6700 is sized and shaped to fit over strap 6400 or 6500 with the strap being captured within the recess defined by a spacer 6730 and arcs 6740 and 6750 are sized and shaped to be engaged about a portion of the upper surface of frames 6100 and 6200, with a tab 6710 and 6720 being sized and shaped to fit within a complementary recess disposed in the tubing, thereby preventing forward or backward movement of the straps.

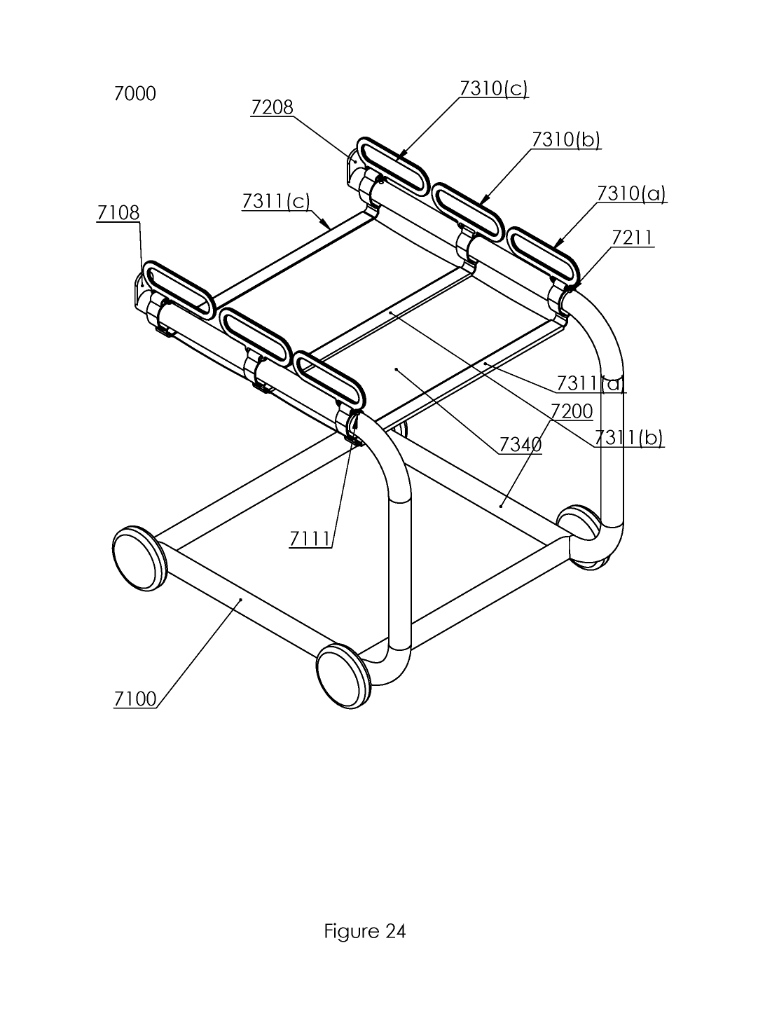

Referring now to FIG. 24, a further embodiment 7000 of a transfer chair Is shown. Transfer chair 7000 has a pair of generally c-shaped tubular frames 7100 and 7200 disposed on opposing sides thereof. There is a seat assembly 7300 comprised of a plurality of strap assemblies 7310(a-c) slideably coupled to a corresponding lateral channels 7311(a-c) within a seating surface 7340.

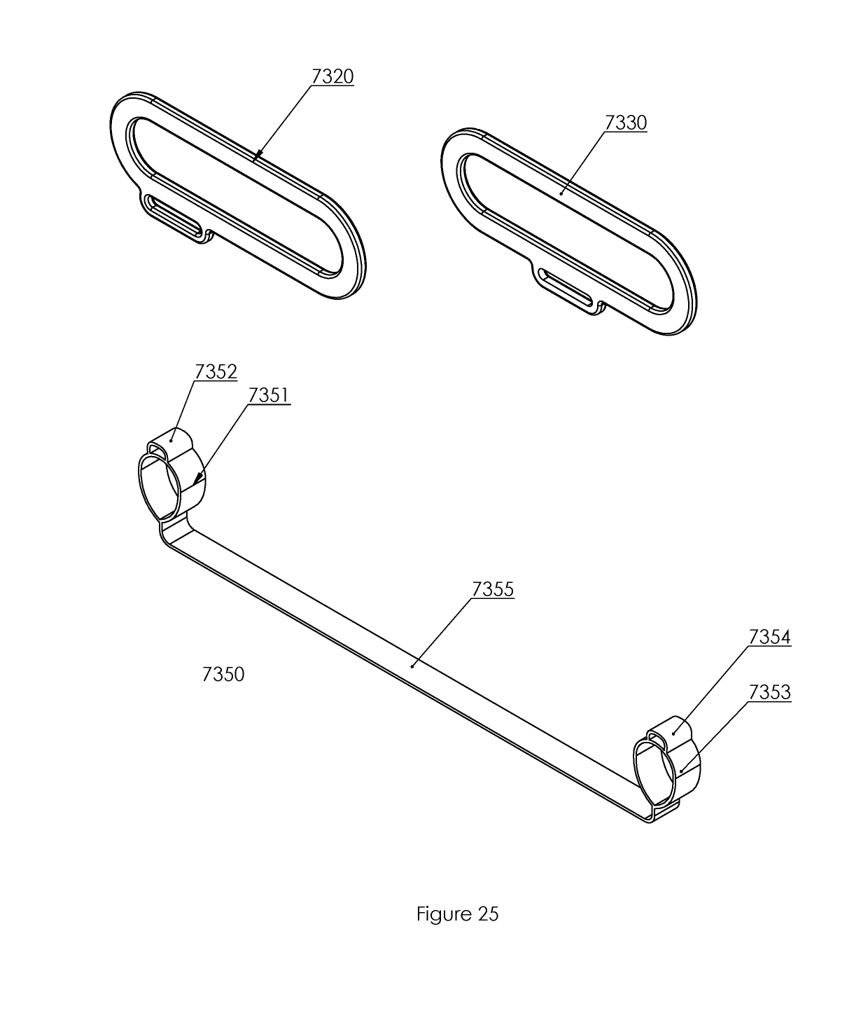

Referring now to FIGS. 24 and 25 together, a transfer chair 7000 has a plurality of handles 7320 and 7330, with the handles having a larger dorsal opening sized and shaped to be grasped by the hand of a user and a smaller ventral opening sized and shaped to be engaged upon a strap 7350 as shown in FIG. 24. Strap 7350 has a plurality of loops disposed at opposing ends thereof. A pair of large loops 7351 and 7353 are sized and shaped to be engaged about a frame 7100 and 7200. Similarly small loops 7352 and 7353 are sized and shaped to be engaged about the ventral aperture of handles 7320 and 7330. A bridge 7355 connects the opposing sides of the strap 7350 and provides operative support for the seat 7430 within channels 7311(a-c).

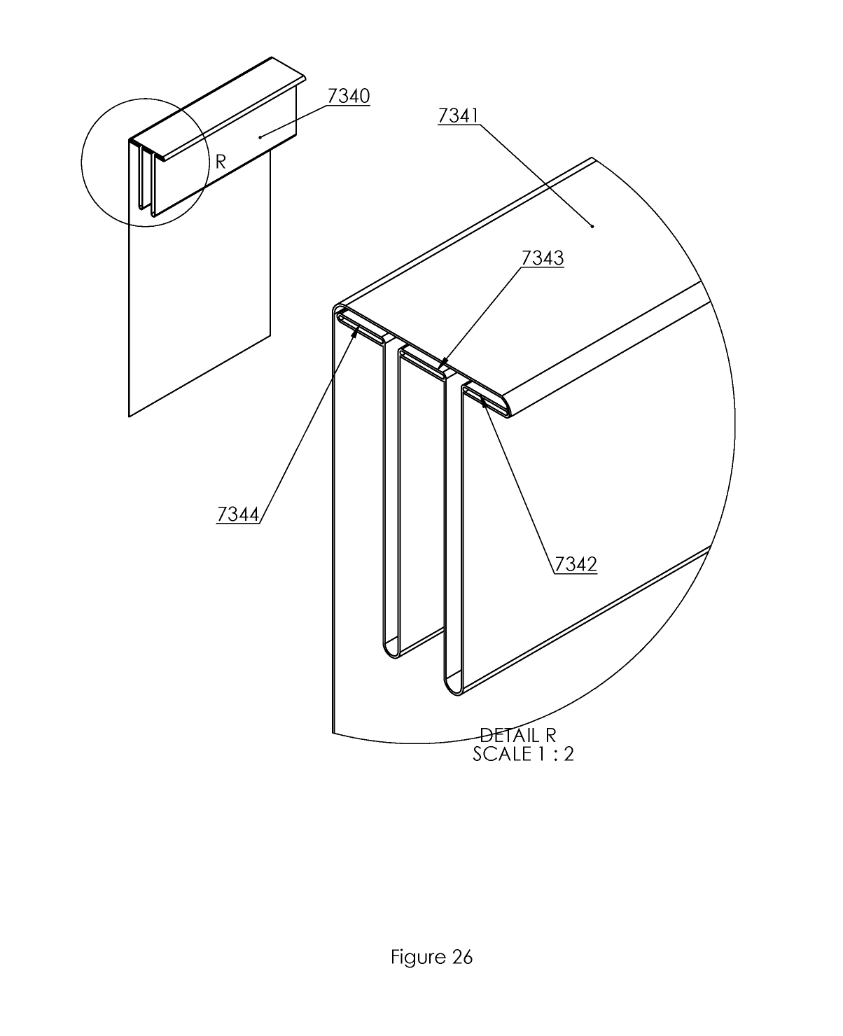

Referring now to FIG. 26 an embodiment of a seating surface 7340 is shown, with the seating surface being a portion of fabric having channels 7342, 7343, and 7344 extending laterally therethrough and being sized and shaped to allow strap 7350 of respective strap assemblies 7310(a-c) therewithin. There is an optional cover 7341 which wraps about the top of the seating surface 7340 so that as the distance between the channels 7344, 7343, and 7342 changes in various configuration of the device, a patient's clothes and/or skin aren't pulled together or apart with said change. Cover 7341 has been removed in the remaining figures for ease of illustration.

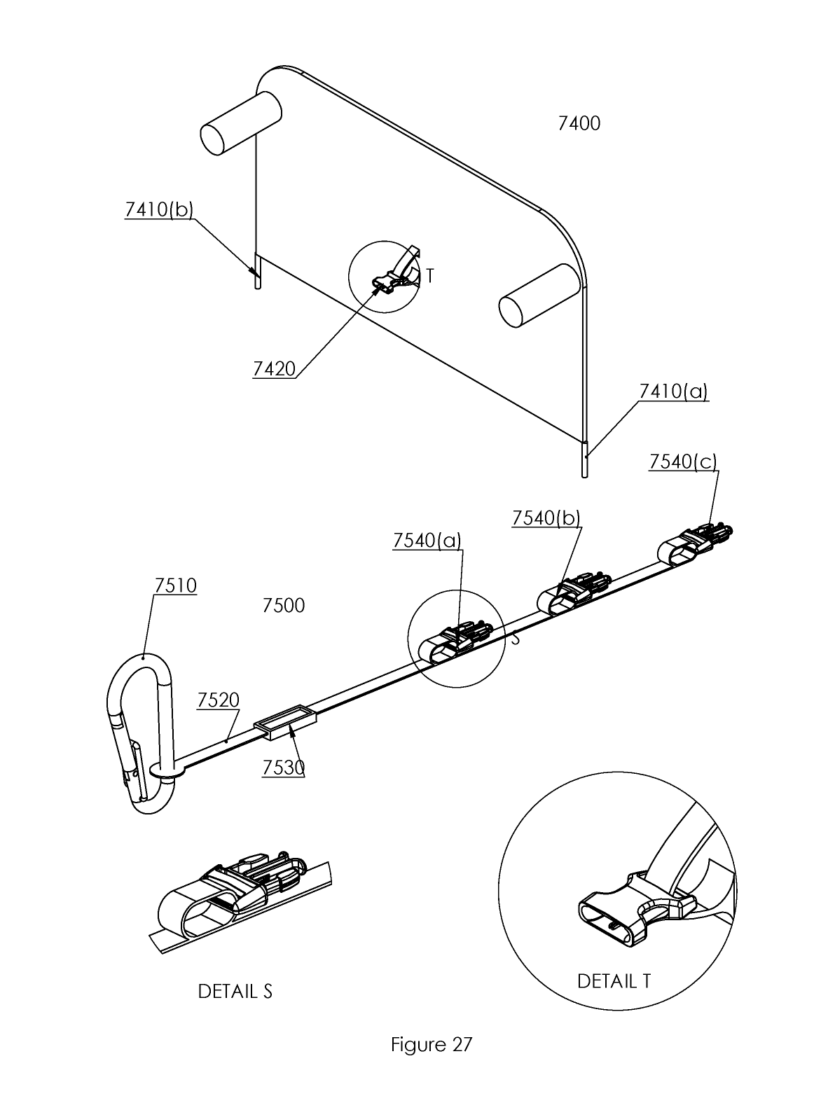

Referring now to FIG. 27, a seat back assembly 7400 is shown, with the seat back assembly having two downward facing pins 7410(a and b) sized and shaped to be engaged upon complementary apertures in frames 7100 and 7200. There is a female slide buckle 7420 coupled to the posterior face of the seat back. There is a strap 7500 having a carabiner 7510 coupled to a first end thereof and a plurality of male slide buckles 7540(a-c) coupled to a second end thereof. There is a webbing slide 7530 disposed upon the strap and coupled to the strap so as to adjust the length of a portion 7520 of the strap. The spacing of the male buckles 7540(a-c) approximates the distance between channels 7342, 7343, and 7344. In use, the strap 7500 is attached after the seat back has been coupled to the frames about a patient facing outward in a car door. Once this has been done, the carabiner 7510 is coupled to the door striker plate opposite the location of the patient. For instance, if the patient is seated in the front-passenger seat, the carabiner should be coupled to the door striker plate of the front driver door. After coupling of the carabiner, the slide 7530 is adjusted so that there is little slack in the strap when slide buckle 7450(a) is coupled female slide buckle 7420. Next, the operator disengages male slide buckle 7450(a) and engages males slide buckle 7540(b) before incrementally moving the patient outward and away from the car as previously described. This arrangement prevents the transfer chair from unpredictably moving away from the car and patient.

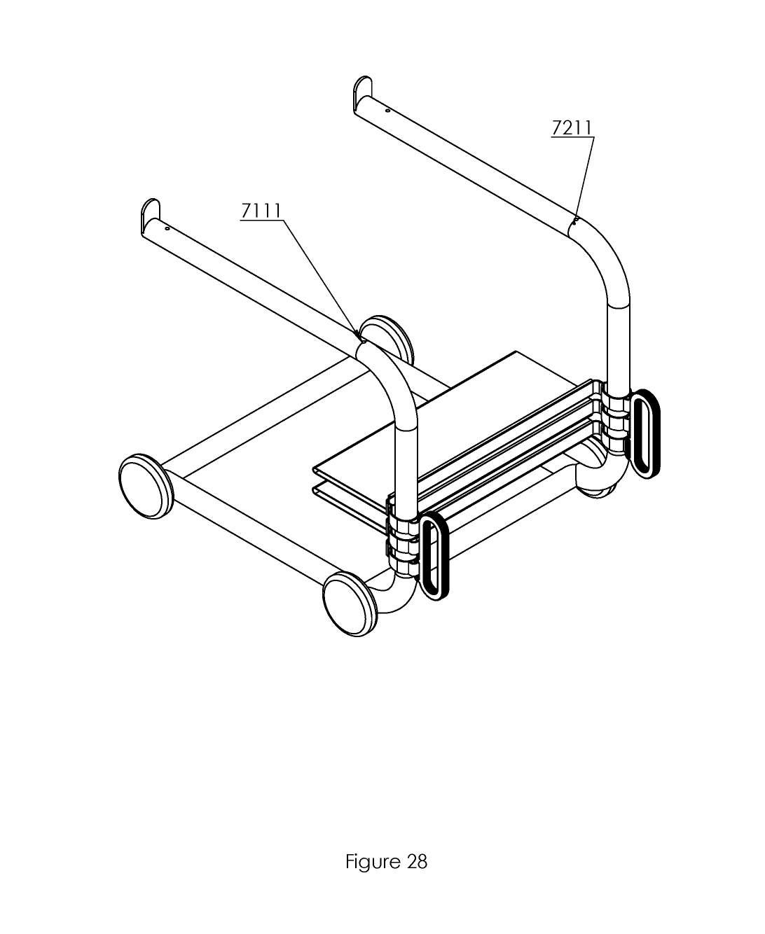

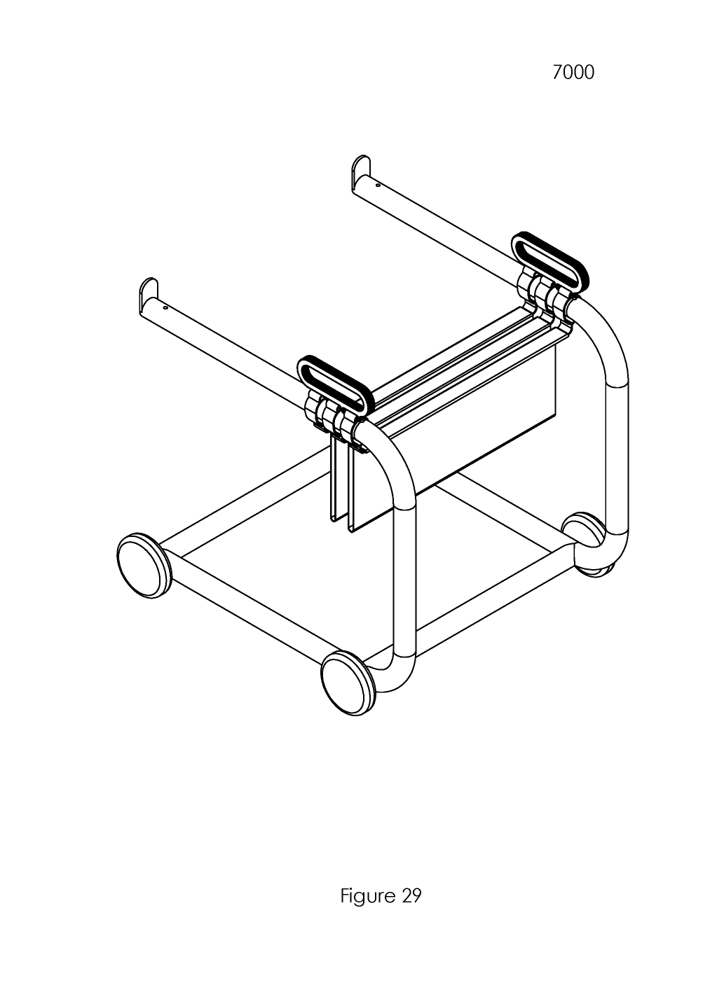

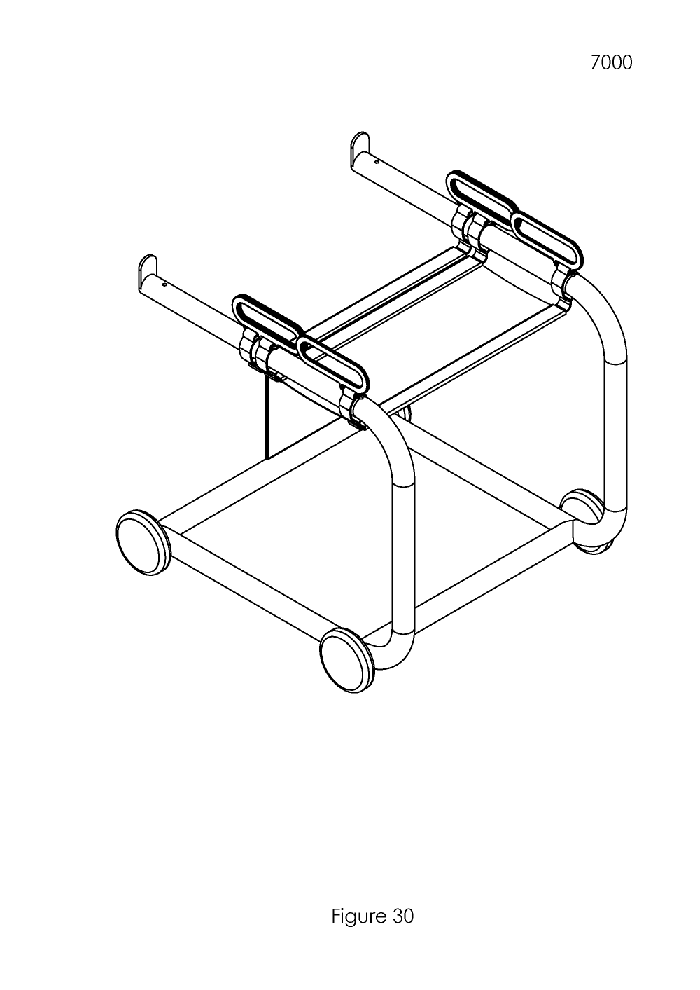

A method of using the transfer chair 7000 will now be described. Initially, the assembly is provided in a first configuration as shown in FIG. 28, with the seat assembly 7300 compressed near the bottom front edge of the frames 7100 and 7200 and with the seat back assembly removed. Next, the transfer chair 7000 is positioned between the Achilles of a patient and an automobile as previously described. Next, the seating surface is translated dorsally so that it is compressed under the bend of a patient's knees as shown in FIG. 29. Next, a pin (not shown, but substantially similar to pin 5330) is inserted apertures 7111 and 7211 to prevent unwanted forward movement of the strap assembly 7310(a). Next, the patient is urged incrementally forward and out of the car seat and the strap assemblies 7310(b and c) are translated posteriorly, leaving strap assembly 7310(a) in place into a configuration as shown in FIG. 30 with strap assemblies 7310(b and c) disposed below the approximate mid-point of the length of the patient's femur. Next, the patient is asked to lean forward and transfer a portion of his weight to the strap assemblies 7310(a and b) while the operator slides strap assembly 7310(c) into the configuration shown in FIG. 24. Finally, a pin is inserted into apertures 7112 and 7212 to prevent unwanted forward movement of assembly 7310(c). Rearward movement of the strap assembly 7310(c) is prevented by backstops 7108 and 7208.

Referring now to FIG. 31, a further embodiment of a strap 7600 is a webbing assembly designed for use with a seating assembly 7300 is shown. Strap 7600 has two large webbing loops 7612 and 7632 sized and shaped to be slideably engaged about frame 7100 and 7200. There is a smaller webbing loop 7611 and 7632 atop loops 7612 and 7632 sized and shaped to be engaged about handles 7320 and 7330. There is a rigid loop 7670 disposed below loop 7612 and 7632 from which a seating loop 7620 hangs. The overall length of seating loop 7620 is adjustable by selectably engaging one of male coupler 7660(a-d) to female coupler 7650. When assembled, the uninterrupted portion of seating loop 7620 is disposed within channels 7311(a-c) while there portion of loop 7600 containing the male and female couplers is disposed outside of and below channels 7311(a-c), thereby allowing an operator to adjust the effective height of the seat assembly 7300 relative to the frames 7100 and 7200.

In various embodiments disclosed herein, a single component can be replaced by multiple components and multiple components can be replaced by a single component to perform a given function or functions. Except where such substitution would not be operative, such substitution is within the intended scope of the embodiments.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

It is understood that, in light of a reading of the foregoing description, those with ordinary skill in the art will be able to make changes and modifications to the present invention without departing from the spirit or scope of the invention, as defined herein. For example, those skilled in the art may substitute materials supplied by different manufacturers than specified herein without altering the scope of the present invention.

What is claimed is:

1. A wheelchair comprising;
a frame having a plurality of wheels in contact with the ground therebelow, a seating surface coupled to the frame by three generally vertical connectors on each side of the seating surface with each connector extending generally downward from the frame to the seating surface, with the connectors defining two seating surface segments which run left to right along the seat, and each segment being individually detachable from its corresponding connectors along at least one side of the seating surface.

2. The wheelchair of claim 1, wherein the distance between the ground and the seating surface is adjustable.

3. The wheelchair of claim 2, wherein the length of the connector between the frame and the seating surface is adjustable.

4. The wheelchair of claim 1, wherein the connectors are flexible cables or straps.

5. The wheelchair of claim 4, wherein the length of the connectors is adjustable.

6. The wheelchair of claim 1, where a connector comprises two portions, a first portion that connects the seating surface to the frame defining the distance X therebetween and a second portion which extends beyond X, wherein the ratio of the length of the first portion to the second portion is adjustable to regulate X.

7. The wheelchair of claim 1, wherein there is a rigid member coupled to the seating surface running left to right along at least the boundary of the first and second segments.

8. The wheelchair of claim 1, wherein there are 4 seating surface segments.

9. The wheelchair of claim 2, wherein the height from the ground of the portion of the frame to which the connectors are suspended is adjustable.

10. A wheelchair comprising;
a rigid frame having wheels near a bottom portion of the frame, with the wheels resting upon the ground, and with the frame supporting a seating surface from a top portion of the frame, with the seating surface being deployable under a seated patient in incremental configurations between a first configuration in which the seating surface extends only under the area directly behind the bend of the patient's knee and a second configuration in which the seating surface extends underneath the majority of a patient's thigh.

15. A wheelchair comprising;
a rigid frame and seating surface coupled to the frame, with the seating surface being sized and shaped to support a seated user in three configurations, a first configuration in which the seating surface is disposed away from and provides no support for the user's thigh, a second configuration in which a first portion of the seating surface is disposed below and supports a first portion of the user's thigh extending from behind the user's knee to a point between his knee and hip, and a third configuration in which a second portion of the seating surface is disposed below and supports a second portion of the user's thigh extending from the first portion of his thigh to a point posterior therefrom.
